(19) United States
(12) Patent Application Publication
(10) Pub. No.: US 2013/0041625 A1
(43) Pub. Date: Feb. 14, 2013

(54) Advanced Statistical Detection of Emerging Trends

(71) Applicants: Aaron D. Civil, Rochester, MN (US); Jeffrey G. Komatsu, Kasson, MN (US); John M. Wargo, Poughkeepsie, NY (US); Emmanuel Yashchin, Yorktown Heights, NY (US); Paul A. Zulpa, Woodbury, CT (US)

(72) Inventors: Aaron D. Civil, Rochester, MN (US); Jeffrey G. Komatsu, Kasson, MN (US); John M. Wargo, Poughkeepsie, NY (US); Emmanuel Yashchin, Yorktown Heights, NY (US); Paul A. Zulpa, Woodbury, CT (US)

(73) Assignee: INTERNATIONAL BUSINESS MACHINES CORPORATION, Armonk, NY (US)

(21) Appl. No.: 13/207,425

(22) Filed: Aug. 11, 2011

(51) Int. Cl. G06F 19/00

(52) U.S. Cl. 702/179

(57) ABSTRACT

Advanced statistical detection of emerging trends in a process is disclosed, based on a Repeated Weighted Geometric Cumulative Sum analysis, which may be combined with time window-based estimation of proportions and related thresholds. Threshold derivation and significance computation is based on parallel simulation runs with power-exponential tail approximations. A battery of tests using the statistical theory of sequential analysis and change-point theory in combination with targets is used to evaluate non-conforming conditions in a process. Trends in fall-out rates are detected based on non-time-to-failure data that corresponds to counts of failures in consecutive time periods, with possibility of delayed input.

### CROSS-REFERENCE TO RELATED APPLICATION

The present invention is related to commonly-assigned and co-pending application Ser. No. ______, which is titled “Hybrid Analysis of Emerging Trends for Process Control” (Attorney Docket AUS920110186US1). This application, which is referred to hereinafter as “the related application”, was filed on even date herewith and is incorporated herein by reference.

### BACKGROUND

The present invention relates to process control, and deals more particularly with automated techniques for detecting emerging trends in a process using statistical analysis of observed process control data.

In today's high-velocity business climate, supply chains are becoming more complex and inventory moves at a rapid pace. Accordingly, supply chains are becoming more vulnerable to out-of-control conditions which can adversely affect product quality, supply, and cost.

### BRIEF SUMMARY

The present invention is directed to detecting emerging trends in process control data. In one aspect, this comprises: applying a Repeated Weighted Geometric Cumulative Sum analysis to process control data to determine whether a threshold is exceeded for the process control data; and flagging the process control data if the threshold is exceeded. The Repeated Weighted Geometric Cumulative Sum analysis preferably comprises iterating over N intervals, each iteration computing a weighted cumulative sum that summarizes all previous evidence against an assumption that an underlying process represented by the process control data is acceptable. Each iteration of the Repeated Weighted Geometric Cumulative Sum analysis preferably further comprises: computing a weighted deviation of a current one of the N intervals from an approximation of a midway point between evidence that an underlying process represented by the process control data is acceptable and evidence that the underlying process is unacceptable; and adding the computed weighted deviation to a value computed at a previous one of the N intervals as the weighted cumulative sum that summarizes all previous evidence against an assumption that the underlying process is acceptable, thereby generating a new value for the weighted cumulative sum, where an initial one of the N intervals uses a value of zero as the value computed at the previous one of the N intervals. A last good period may be computed from the process control data by applying the Repeated Weighted Geometric Cumulative Sum analysis to locate a point M in the process control data that represents a peak in the process control data, the point M starting a segment in the process control data in which a value computed by multiplying the threshold by a ratio is not exceeded up through a current time T, the segment following an earlier point in the process control data where the value is exceeded. At least one supplemental test may be used in addition to the Repeated Weighted Geometric Cumulative Sum analysis to determine whether to flag the process control data. A threshold may be generated for use in the Repeated Weighted Geometric Cumulative Sum analysis using parallel simulation runs with power-exponential tail approximations. In another aspect, an embodiment of the present invention computes thresholds (and optionally confidence levels) for use when evaluating acceptable conditions in a process using parallel computation of simulated trajectories.

Embodiments of these and other aspects of the present invention may be provided as methods, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

### BRIEF DESCRIPTION OF THE SEVERAL VIEWS OF THE DRAWINGS

The present invention will be described with reference to the following drawings, in which like reference numbers denote the same element throughout.

FIG. 1 provides a flowchart illustrating a high-level view of operation of an embodiment of the present invention;

FIG. 2 provides a flowchart illustrating establishment of thresholds for use in an embodiment of the present invention;

FIG. 3 provides a sample chart that is used to illustrate determining the last good period in a data set; and

FIG. 4 depicts a data processing system suitable for storing and/or executing program code.

### DETAILED DESCRIPTION

Advanced statistical detection of emerging trends in a process is disclosed, based on a Repeated Weighted Geometric Cumulative Sum analysis, which may be combined with time window-based estimation of proportions and related thresholds. Threshold derivation and significance computation is based on parallel simulation runs with power-exponential tail approximations. A battery of tests using the statistical theory of sequential analysis and change-point theory in combination with targets is used to evaluate non-conforming conditions in a process. Trends in fall-out rates are detected based on non-time-to-failure data that corresponds to counts of failures in consecutive time periods, with possibility of delayed input.

In today's highly-competitive and high-velocity business climate, supply chains are becoming more vulnerable to out-of-control conditions which can adversely affect product quality, supply, and cost. Businesses will therefore benefit from early detection of problems or negative trends, which in turn allows for quickly containing suspect inventory and reducing costs associated with taking remedial actions.

Conventional techniques for analysis in a process control environment, such as the well-known Shewhart analysis and “TQM” (“Total Quality Management”), may be inadequate in the type of complex supply chain environment that is present today. These known techniques require accumulation of, and analysis of, a significant amount of evidence before it becomes possible to determine an out-of-control condition. Accumulating the large amount of evidence requires passage of a relatively long time interval, with a result that problem detection often occurs too late to avoid costly disruption of the supply chain. This late detection increases the cost of containment actions. One known technique for attempting to mitigate these known issues is to tighten the process control targets that are used. Tightening the targets causes the corresponding trend analysis to increase detection. However, a consequence of this tightening is the injection of a large number of false warnings. That is, while the analysis may appear to be detecting quality issues when using tightened targets, further analysis often shows that a number of the detected “problems” are not problems at all, and instead are due to natural volatility and/or randomness in the observed data.

The present invention is directed to detecting emerging trends using statistical analysis of observed process control data, and an embodiment of the present invention enables using trace evidence—sometimes referred to as forensic evidence—in place of the statistically-significant samples that are required by known techniques. The disclosed approach provides early detection of negative process trends, allowing an enterprise to begin containment actions before widespread impact on the supply chain occurs, while at the same time yielding a low rate of false alarms. As a result of this early problem detection of out-of-control or unfavorable conditions, personnel and other resources can be quickly directed to containment and corrective action, which provides savings in time, labor, and process costs. In particular, as noted earlier, the costs associated with remediation can be lowered when containment and corrective action begin before an emerging defect has a significant impact on the supply chain.

An embodiment of the present invention provides early detection of unfavorable conditions (in terms of quality and reliability) and does so regardless of the magnitude of the sample size, while maintaining a tunable low rate of false alarms. Analysis may be provided at the level of an individual product or part, and/or for groups thereof (including groups of groups, to an arbitrary level). An embodiment of the present invention may be used with irregular (e.g., time-delayed reporting, time-managed) data streams, and may be used without regard to the nature of the data (e.g., without regard to attribute types of the data).

As will be disclosed in more detail below, a battery of tests is produced that uses the statistical theory of sequential analysis and change-point theory, in conjunction with parameter targets (which may be provided by process control professionals and/or from automated means, including the approach disclosed in commonly-assigned U.S. patent application Ser. No. 13/194,910, which is titled “Trend-Based Target Setting for Process Control”), to produce a statistically efficient (i.e., high signal-to-noise ratio) selection and ranking mechanism for non-conforming conditions. The non-conforming conditions may also be prioritized, so that attention of process control professionals can be directed towards conditions that are most important. An embodiment of the present invention may be used with a process control dashboard, and the ranking and prioritization may comprise providing visual and/or audible warnings or other messages using the dashboard, giving the process control professionals an easy-to-interpret graphical representation that facilitates interpretation of the obtained signals and diagnostics. Temporal relevance is established for non-conforming conditions—for example, by assessing and mathematically summarizing the current state of the process. An embodiment of the present invention may be configured relatively easy, and may require only one parameter (e.g., a tuning parameter that allows making a tradeoff between false alarms and sensitivity) to be input by a process control professional.

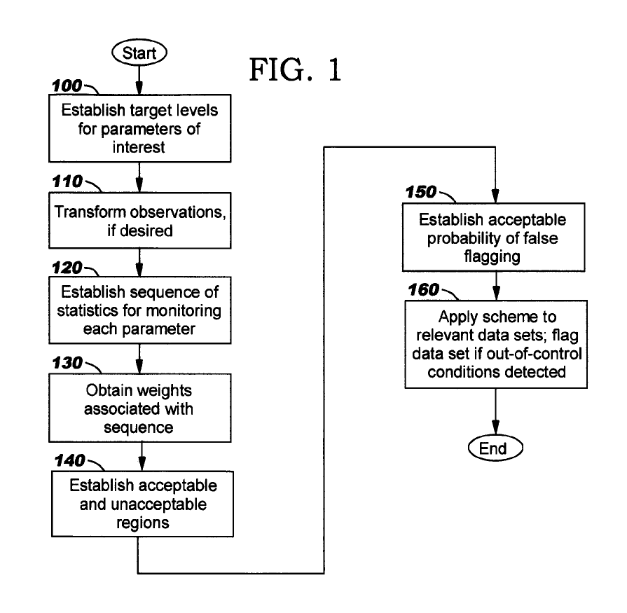

An embodiment of the present invention preferably uses a main scheme and a set of supplemental schemes. Several key data sets are used as input to these schemes. A first set of input data is the actual performance (i.e., process control) data that will be analyzed. A second set of input data is the targets that are applicable to these data. A third set of input data is the bounds of unacceptable performance for each set of performance data. A fourth set of input data is the set of confidence measures for what is considered valid warnings for each set of performance data. A general approach used by an embodiment of the present invention is shown in FIG. 1, as will now be discussed.

Target levels are established for parameters of interest (Block 100), and the observed data may be transformed if desired (Block 110). For example, suppose that the observations are in terms of the percentage of defective products from a process. There may be different variances in the data, depending on the sample size (where a smaller sample size generally leads to increased variability). It might be desirable to use the square root of the variance instead of the observed variance, or perhaps the natural logarithm of the observed variance if the distribution is skewed, as a means of reducing the amount of variance by suppressing outliers. As a result, the data will have more similarity or symmetry in variance, and may improve the rate of sensitivity for a given rate of false alarms. Accordingly, Block 110 corresponds to computing the square root as a transform of the observed variance, in this example.

A control sequence of statistics is established for every parameter of interest and will serve as a basis for the monitoring scheme (Block 120). The symbol (i.e., lambda) is used herein to refer to a parameter that is to be evaluated, and the notation {X,}—or equivalently, {X(i)}—is used herein to refer to the control sequence of statistics, where “i” serves as an index having values 1, 2, . . . for this sequence. As an example, a parameter of interest may be the fall-out rate of a process, and a control scheme for monitoring this fall-out rate may be an analysis of defect rates observed in consecutive monitoring intervals. In this example, X(1) corresponds to the fall-out rate for the first monitoring interval, X(2) corresponds to the fall-out rate for the second monitoring interval, and so forth. (Monitoring intervals are referred to hereinafter as weeks, for ease of discussion, although it will be apparent that other intervals may be used without deviating from the scope of the present invention.)

A set of weights may be obtained for use with each control sequence (Block 130). The set of weights may be represented using the notation {wᵢ}—or equivalently, {w(i)}—where each weight w(i) is associated with a corresponding statistic X(i) from the control sequence {X(i)}. As an example, when the parameter is the fall-out rate for a defect, the weights may correspond to sample sizes which are observed in each of the monitoring intervals in order to provide a weighted fall-out rate, where it may be desirable to associate a higher weight with larger sample sizes. Weights may be assigned in other ways, including by consulting stored policy, without deviating from the scope of the present invention.

Acceptable and unacceptable regions for performance of the control scheme are established (Block 140). This is generally represented in the art using the notation λ₀<λ₁, where λ₀ represents an acceptable region and) represents an unacceptable region.

An acceptable probability of false flagging is also established (Block 150). That is, a determination is made as to what probability is acceptable for flagging a process as being defective when it is actually not defective. In view of this probability, a threshold h, where h>0, is determined for the desired tradeoff between false alarms and the sensitivity of the analysis.

The control scheme is then applied to every relevant data set (Block 160), and a data set that shows out-of-control conditions, when applying this control scheme, is flagged.

An embodiment of the present invention applies a main scheme and one or more supplemental schemes, as stated earlier. These schemes will now be described.

The main scheme used in an embodiment of the present invention is preferably a Repeated Geometric Weighted Cusum scheme, as will be described. Suppose that at time T, process control data are available for some number of vintages, “N”. When the monitoring interval is a week, for example, then a vintage corresponds to the process control data observed during a particular week. The observed data for the N vintages are then transformed from {X(i)} to a sequence {S(i), i=1, 2, . . . N} having the following properties:
S₀=0, Sᵢ=max [0, γSᵢ₋₁+wᵢ(Xᵢ₋ₖ)] (referred to hereinafter as “Scheme A1”)

where k=(λ₁−λ₀)/(ln λ₁−ln λ₀), which is approximately equal to (λ₁+λ₀)/2, given that γ is an element of the interval [0.7, 1].

That is, from input {Xᵢ}, output {Sᵢ} is created (thus converting a data chart to an evidence chart), where {Sᵢ} reflects evidence against the assumption that a process is acceptable. At every step, i, the evidence used is only from the previous interval Sᵢ₋₁ and that is combined with the most-recent data, in a recursive manner. The value of Sᵢ at any particular step i is therefore a weighted cumulative sum that summarizes all previous evidence against the assumption that the process is acceptable. With reference to the example where an interval corresponds to a week, the evidence Xᵢ for a particular week, i, is combined with existing evidence at point i (that is, the evidence Xᵢ₋₁, which represents all previous weeks, i=1, 2, . . . i−1), to get new evidence through week i. This contribution of the new vintage is weighted in the expression [wᵢ(Xᵢ₋ₖ)].

Note that k is chosen such that it serves as an approximation of the midpoint between evidence that the process is acceptable and evidence that the process is unacceptable. If evidence for a particular vintage more closely aligns to an unacceptable process, in which case Xᵢis close to 1₁, then the expression (Xᵢ₋ₖ) from [wᵢ (Xᵢ₋ₖ)] is approximately [λ₁−((λ₁+λ₀)/2)], which is generally a positive number. Accordingly, the evidence will tend to grow as the weighted contribution for this vintage is accumulated in Sᵢ. On the other hand, if evidence for a particular vintage more closely aligns to an acceptable process, in which case Xᵢ is close to λ₀, then the expression (Xᵢ₋ₖ) from [wᵢ(Xᵢ₋ₖ)] is approximately [λ₀−((λ₁+λ₀)/2)], which is generally a negative number. Accordingly, the evidence will tend to decrease as the weighted contribution for this vintage is accumulated in Sᵢ.

Then, define S=max [S₁, S₂, . . . S_{N}]. This corresponds to the maximum value of the evidence, for all N vintages. This value of S will be used for the decision about whether the data set at time T shows an out-of-control condition. Accordingly, S is compared to a threshold, h, and if S exceeds this threshold, then the data set is flagged (and an alarm may be triggered). Otherwise, when S does not exceed the threshold h, this indicates that all observations are less than the threshold, so the data set is not flagged (and an alarm is not triggered).

The value of threshold h is chosen according to the following equation:

Prob{S>h|N, λ=λ_{0}}1=1−α₀

That is, h is chosen so that the probability of flagging the data set as out-of-control when the process is acceptable (where the notation) λ=λ₀ indicates an acceptable process), which is a false flagging, is small. If the desired probability of false flagging is 1 percent, for example, then α₀ is 0.99 in the above equation. For the resulting h, one can then state with 99 percent confidence that no false alarms will be produced for acceptable process levels.

The above computations are selected so that as a process gets better, the evidence against the assumption that the process is acceptable will start to decrease, but cannot decrease less than zero by the definition of Sᵢ, and as the process gets worse, the evidence starts to grow because the contribution [wᵢ(Xᵢ−k)] tends to be positive.

It may happen that data is updated for a previous interval. For example, new information might be obtained which indicates that the fall-out rate for 5 weeks ago needs to be updated. Accordingly, an embodiment of the present invention is designed such that an alarm can be triggered even in the presence of a time delay (e.g., for a time-delayed data stream). The value γ from the expression Sᵢ=max [0, γSᵢ₋₁+wᵢ(Xᵢ−k)] allows suppressing current evidence Sᵢ₋ᵢ before superimposing new evidence from [wᵢ(Xᵢ−k)]. The value γ therefore a tuning parameter that allows making a tradeoff between false alarms and sensitivity to different types of changes (such as shift or drift), and is typically selected by process control professionals in view of their knowledge of the process control data. As will be obvious, the value γ may be set to 1 to not suppress any evidence.

Suppose, as an example to illustrate the above computations, that λ₁ is set to 3 percent and λ₀ is set to 1 percent. In this example, a 1 percent fall-out rate is deemed to be acceptable (perhaps to protect against false alarms), but a 3 percent fall-out rate is unacceptable. These values may be selected, for example, by a process control professional or generated by an automated target-setting system. A policy might be used that applies an algorithm to compute both λ₀ and λ₁ from a target that is generated by a target-setting system, such as setting λ₀ to 2 times the generated target and setting λ₁ to 4 times the generated target.

Turning now to the supplemental tests that may be used with an embodiment of the present invention, it may be useful in some cases to use supplemental tests to enhance detection capability of the control scheme. For example, while the equation S=max [S₁, S₂, . . . S_{N}] is used to trigger an alarm, it is not specifically tuned to emphasize data from more recent weeks over data from older weeks, and this may be desirable in some cases to provide a focus on recent events in the process. This may be useful, for example, when evidence for a process includes data from periods of both activity and inactivity. Suppose that a particular product is inactive for an interval of time, but the process control professionals desire to keep some focus on the product. During the period of inactivity, supplemental tests are not needed. When the product becomes active again, however, supplemental tests may be used to provide focus on the now-recent activity.

Supplemental tests are generally useful in cases where data arrives with a time delay, and their use is generally data-specific and policy-specific. Accordingly, an embodiment of the present invention uses criteria that are defined for establishing whether supplemental tests are needed. As one example, a criterion might specify that supplemental tests are to be applied for all components of type “A”. As another example, a criterion might specify that supplemental tests are to be applied for all components that had shipments with the last “X” days.

Several supplemental tests will now be described. (As will be obvious, there are merely illustrative of supplemental tests that may be used, and an embodiment of the present invention may use additional and/or different supplemental tests without deviating from the scope of the present invention. Note also that supplemental tests may be used singly, or in combination.) A first supplemental test uses the last value of scheme S_{N}, and flags the data set if S_{N}>h₁. A second supplemental test uses the number of failures within the last period of length “L”, and flags the data set if L_{(L)}>h₂, where X_{(L)} represents the number of failures observed within the last L days. A third supplemental test is based on evaluating extreme intermediate points in a data set, and flags the data set if Xᵢ>λ₀+(h₃/Sqrt (wᵢ)), where wᵢ might correspond to the sample size and Sqrt (w)—that is, the square root of (wᵢ)—might therefore be related to the standard deviation.

The threshold values hᵢ in the first two of these three supplemental tests may be established based on the following criteria:

Prob {S_{N}>h₁|N, λ=λ₀}=(1−α₀)/m

Prob {X_{(L)}>h₂|N, λ=λ₀}=(1−α₀)/m

where “m” is chosen high enough to satisfy tolerance for overall deviation from the target probability of false flagging for the battery of tests.

The threshold value h₃ in the third of the three supplemental tests may be established based on the distributional properties of Xᵢ.

In each of these described supplemental tests, the test is directed toward determining the probability of exceeding a threshold when the process, as observed over N weeks, is acceptable (i.e., when λ=λ₀), and the probability should therefore be small. With reference to the second supplemental test, for example, suppose that the process control professional wants to focus on the number of failures in the most-recent 2 weeks. The value L is 14 in this example, and the second supplemental test will trigger an alarm if the number of failures in this 14-day interval exceeds h₂.

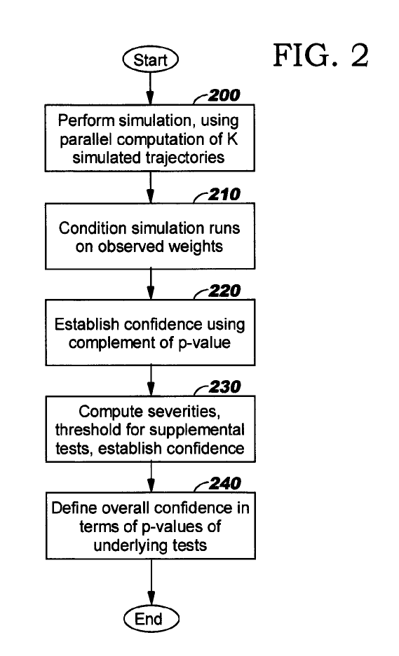

The main and supplemental tests rely on establishment of suitable thresholds. According to an embodiment of the present invention, thresholds may be established using the approach illustrated in FIG. 2, which will now be described.

An embodiment of the present invention begins the threshold establishment process by simulation, with parallel computation of K simulated trajectories corresponding to an on-target value of λ₀ (Block 200). That is, suppose that a process is at an acceptable level λ₀, with samples taken over N weeks. It is desirable to know how the trajectory of evidence will look under these conditions—and in particular, how high the trajectory will go—so that a suitable threshold can be chosen, given that the threshold should be high enough that the probability of exceeding the threshold is small while still protecting against false alarms. Therefore, simulation of data Xᵢis used to see what happens to the process at λ₀.

The simulation runs are conditioned on the observed weights w₁, w₂, . . . 2_{N} (Block 210).

Together with the thresholds, the same simulation runs are used to establish confidence of the observed condition (Block 220). For example, if the value of S observed for a given variable is S-tilde, then the confidence can be computed as the complement of the p-value of the following test:

Prob {S>S-tilde|N, λ=λ₀}=p

Note that the complement of a p-value reflects the probability of staying within the confidence bounds.

Simulation is used in a preferred embodiment because establishing thresholds and levels of confidence for a process {Sᵢ} most likely cannot be solved analytically, given complex processes. The processes to which an embodiment of the present invention are applied are all stationary (under the assumption that the process level is acceptable) and are defined on a finite time segment that includes N vintages. Therefore, it is known that the thresholds and p-values exist and can be estimated with an arbitrary degree of precision, using a sufficient number of simulation runs. Therefore, convergence per se is not an issue. Preferably, the number of simulation runs is on the order of K=2,500 trajectories, which leads to a predictable amount of required computing power.

A preferred embodiment does not perform simulations one trajectory at a time, for some number N intervals of data (such as N=52 weeks) and some number of K simulations (such as K=1,000), and compute statistics from this data because it is generally computationally expensive and inefficient, and would require simulating a sequence of N variables Xᵢ, each having a different distribution (i.e., because the weights, which come from the sample sizes, are varying along the trajectory), for each of K times. Instead, an embodiment of the present invention simulates K replicas of each of the N intervals, and computes an evidence chart sequentially over the number of weeks. That is, K replicas of week 1 are simulated to generate K values of X₁ and then update K values of S₁, and then K replicas of week 2 are simulated to generate K values of X₂ and then update K values of S₂, and so forth. This is repeated until K values of X_{N} are simulated, corresponding to the last vintage, when the scheme is updated and threshold and p-values are obtained based on the resulting N values of the main and supplemental schemes. This is an efficient process because it is focused on simulating K values of Xᵢ(which are identically distributed random variables) where sequence Sᵢ is computed as a vector simultaneously for all K trajectories, progressing in time until reaching the current point N, while updating the value of S (as a vector) at each step. This approach relies on the fact that the sample size is known, and simulates the N replicas from the known sample size (which is a relatively cheap computational operation, as the computing power required to obtain K realizations of a given random variable increases very slowly with K). The estimated thresholds and p-values resulting from this approach are deemed to be close enough to “real” thresholds and p-values for practical purposes.

In a similar manner to Blocks 200-220, severities and thresholds for supplemental tests are computed (Block 230). These computations preferably proceed in parallel with the computations of p-values of the main test. These confidence levels are denoted by (1−p₁, 1−p₂).

The overall confidence for the battery of tests can then be defined (Block 240) as some function of p-values of underlying tests (p, p₁, p₂). One example of such a function is shown in the following notation:

max {1−p, 1−p₁, 1−p₂}.

The simulation procedure can generally be made more efficient by using approximations that are inspired by the asymptotic theory of Cusum processes. In particular, instead of, say, K=2500 replications to estimate the thresholds and severities directly, one might use only K₁=500 replications in order to fit the following relationship (which is referred to hereinafter as “equation M1”):

Prob{S>x|N, λ=λ₀}≈A*exp[−a*x+b*ln(x)+c*x⁻¹]

in the area exceeding the observed 75-percent quantile of the empirical distribution of K₁=500 replications of S. The above approach takes advantage of the ability to obtain a high-quality estimate of the 75% quantile x_{0.75}, where this estimate is hereinafter denoted as Est(x_{0.75}) for ease of reference. An immediate estimate of A, denoted by Â, can then be obtained in terms of other parameters, according to the following equation (which is referred to hereinafter as “equation M2”):

Â=Est(x_{0.75})/exp[−a*Est(x_{0.75})+b*ln(Est(x_{0.75}))+c*Est(x_{0.75})⁻¹].

Now, what remains is to fit the upper 25-percent quantile of the 500 replications (in this example) to the equation M1, with A replaced by Â. To obtain a monotonically-decreasing function in equation M1, parameters must be chosen to satisfy the relationships s>0, c>=0, and b²<=4ac. Once the suitable estimates of (a, b, c) are found (for example, through least-squares fitting or maximum-likelihood fitting), the thresholds and p-values (and related severities) can simply be estimated based on equation M1.

In some cases, an estimate of sufficient accuracy can be obtained by setting (b=0) in equation M1, or by setting (b=c=0). The mechanism for estimation of equation M1 under these equations is similar to that which is described above.

Similar methodology is preferably used for deriving thresholds and severities corresponding to supplemental tests. This derivation is done in parallel, according to an embodiment of the present invention, based in the same set of simulated replications.

By way of illustrating the above discussion of equation M1, suppose that 1,000 trajectories are replicated, which gives 1,000 maximum points for the scheme. The threshold should be established so that the probability of the maximum points exceeding the threshold is small when the process is acceptable. For example, the probability might be 0.01 (i.e., 1 percent). Establishing the threshold might be done by estimating the tail of the 1,000 maxima (where the tail corresponds to the distribution of high values for S). If the tail decreases exponentially by A^{[-ax+b*(ln(x))+c*(x**-1)]} as in equation M1 and estimates for the coefficients (A, a, b, c) are available (based on the data and, possibly, theoretical properties), then the equation M1 approximates the tail of the distribution for maxima S. In light of this approximation, the probability that the maxima exceeds the threshold is given by the above-discussed equation Prob {S>h|N, λ=λ₀}=1−α₀, which can be readily solved. The left-hand side of equation M1 can be set to a desired value, such as 0.01, and solving for this value yields the value for the threshold.

By way of illustrating the above discussion of equation M2, suppose that 500 trajectories are replicated, which gives 500 maximum points for the scheme. The median, or 50-percent quantile, has 250 points on the left-hand side and 250 points on the right-hand side, and the 75-percent quantile has ¾ of the points on the left-hand side and ¼ of the points on the right-hand side. This may be suitable for lower quantiles, but in higher quantiles, too much variability is generally present. For example, a 1-percent quantile would have only 5 points on the left-hand side, and 495 on the right-hand side. Accordingly, for use with the higher quantiles which are desired in an embodiment of the present invention, an estimate of Est(x_{0.75}) is first obtained from a histogram, and this estimate (if the values a, b, c are assumed known) leads to an estimate of A based on equation M2. More particularly, equation M1 is preferably set equal to the value suggested by the histogram at the 75-percent quantile (i.e., ¾ into the tail). From this point on, a curve as described by equation M2 is fitted to the data instead of using a histogram, due to the fact that a curve is better adapted to dealing with the amount of variability in the very high quantiles (such as a 99-percent quantile that corresponds to a 1 percent threshold). If the values (a, b, c) cannot be assumed known, they are also estimated based on the data, in light of equation M2. Use of equation M2 simplifies the estimation process, since we now only need to estimate 3 parameters (a, b, c) instead of 4 parameters (A, a, b, c).

A capability of the approach which is disclosed is to provide output specifying qualities related to periods of acceptable and unacceptable behavior. One particular output is referred to herein as the “last good period”, or “LGP”. Obtaining the last good period is performed by programmatically looking backward into history from the current point in time, T, until clearly identifying 2 regimes: a regime where the process was unacceptable (a “bad” regime), followed by a regime where the process was acceptable (a “good” regime). If the search stops immediately, this means that the most recent point is sufficiently unacceptable that there cannot be any last good period. If, however, the search progresses deeper into the history, this proceeds to identify potential “last bad points”, B, so that the regime to the right of these points is considered “good”. The disclosed approach also ensures that the points to the left of the B (i.e., prior to B) are actually bad. If the beginning of the data is reached without finding a bad regime, then the conclusion is that all the data set is compatible with the acceptable process level. (This conclusion could, however, be overturned by supplemental tests.)

In the return code obtained from processing data for a given product, the indicator of existence of the last good period plays a special role, as it enables determining when was the last point in time that data conforming to unfavorable process conditions were observed, and whether there was any data afterwards that conformed to acceptable conditions.

According to an embodiment of the present invention, the last good period is set to a value M (which represents a window depth looking backwards, from the current time T) if M₀>M can be identified for which each of the following four conditions (referred to hereinafter as “the four required conditions”) are met:

1. Starting from time i₀=T−M₀, where M₀>M, the above-discussed Scheme Al does not exceed a threshold h*, where this threshold h* is computed by the formula h*=hv, where h is the threshold of this scheme and v is the ratio

v=Σ_{k-1 . . . K}S_{N}(k)/Σ_{k-1 . . . K}S(k)

and where S(k) and S_{N}(k) represent the maximum value (that is, the above-discussed value S=max [S₁, S₂, . . . S_{N}]) of Scheme A1 and the last value of the supplemental test described above with reference to threshold h₁ was observed in the k-th simulated replication of the scheme, under the condition λ=λ₀. If the denominator in ratio v is 0 (in which case the numerator will also be 0), then v is set to 1.

2. Starting from time i₀=T−(M₀+1), however, Scheme A1 does exceed the threshold h*.

3. The maximum value of Scheme A1 is achieved at time iₘₐₓ=T−M.

4. No supplemental criterion of the type discussed above with reference to threshold h₃ (if present) has triggered an alarm within the last M points.

As can be seen from the above, the search for the last good period is implemented by exploring the values of Scheme A1, proceeding from the current point in time, T, backward until the points (M₀, M) that satisfy the 4 conditions set out above are found. For example, if the point M that defines the last good period represents 10 weeks, then M₀ must represent a deeper point backwards into the history, and thus M₀ will represent a point more than 10 weeks earlier than the current time T. Note that this procedure of establishing the last good period requires only the values of the scheme and the list of alarms related to the supplemental criterion discussed above with reference to threshold h₃ (if present). If the search procedure reaches the beginning of the data and the points (M₀, M) satisfying the above conditions are not found, then a preferred approach sets M=T (in other words, concluding that all the data is compatible with the acceptable level λ=λ₀). This is because the disclosed approach is effectively looking for a pattern of data corresponding to an “unacceptable” segment followed by an “acceptable” segment, and failure to find such segments indicates that no “unacceptable” segment has been identified. Thus, the entire set of data can be treated as a segment that is better explained by an acceptable process level.

It may be desirable in some cases to choose a higher ratio v for use in the computation of h* than the value shown above, which is computed by summation over K iterations of the scheme. Values as high as v=1 may be suitable in some cases.

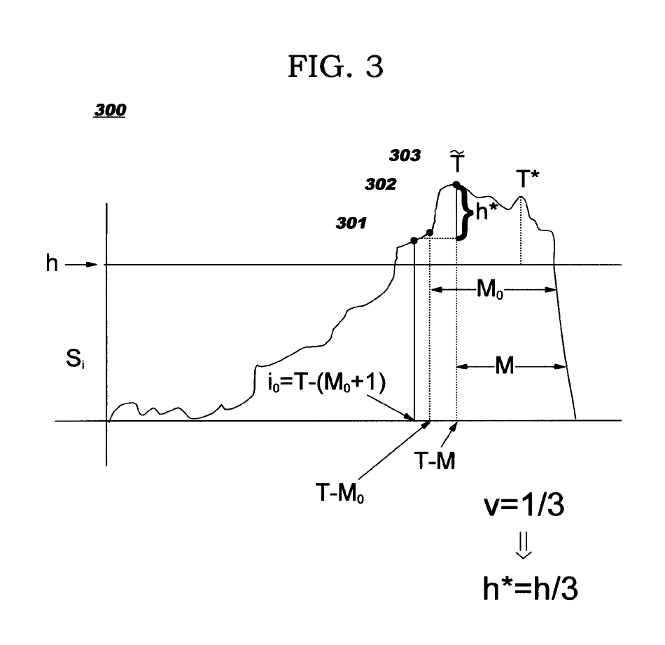

An example of establishing the last good period will now be described in more detail with reference to the sample chart 300 in FIG. 3. The trajectory of the evidence curve {Sᵢ} is depicted. Point T represents the current point in time. By looking back from T, the points in time (T−M₀, T−M) are located M₀ and M units of time ago, respectively, where M₀>M. At these points (T−M₀, T−M), the evidence raises by magnitude almost h* when starting from time i₀=T−M₀, and by more than h* when starting from time i₀=T−(M₀+1). Using a ratio v=⅓ in this example implies that h*=h/3 (where h* indicates the “badness” of the preceding period). The peak in the evidence {Sᵢ} is seen at point T-tilde, after which the evidence started decreasing. So, the last good period started at time T−M=T-tilde (which is also the “last bad point”). In addition, the bad period is found, starting prior to time i₀=T−(M₀+1), followed by the last good period, and thus the pair (M₀, M) is found that satisfy the 4 requirements which were discussed earlier. FIG. 3 also illustrates that the evidence curve need not decrease uniformly, and the sample curve for evidence {Sᵢ} includes a point T* which appears as a small peak. This point T*, however, is not the beginning of the last good period because it is too small to qualify as the last bad point—that is, there is no M₀ starting from time i₀=T−(M₀+1) for which the scheme {Sᵢ} reaches its peak at T* and satisfies the four required conditions. It should also be noted that the point T-tilde does not have to be the highest peak of the whole trajectory to become the starting point of the last good period. (Note that the points shown at 301, 302, 303 in FIG. 3 each correspond to a different week from the time scale, and that a point is graphed in the evidence curve for each week although only 3 such points are specifically identified in this example.)

A graphical representation of the last good period may be provided on the process control dashboard, allowing process control professionals to visualize the current state of the process and to identify and estimate the good and bad regimes, as well as the points of change (commonly referred to as change-points).

As has been demonstrated, an embodiment of the present invention provides a high level of statistical efficiency, and in particular, is capable of delivering high detection capability of emerging negative trends—at an early point—while keeping the rate of false alarms at a pre-specified low level. Input from multiple data sets can be analyzed in a manner that is computationally efficient, while capable of handling a very large number of variables and very high data volume with a relatively low memory footprint, and parallel or vector processing enables the monitoring effort to be highly scalable. The recursive nature of the detection processes enables simulating the scheme trajectories simultaneously, rather than one-by-one, thereby accelerating the process of decision making. A minimal amount of input from process control professionals is needed for configuring the system, and the alarm prioritization produces information for a dashboard display that assists the process control professionals in understanding the current trends and responding accordingly. Additional or different detection rules, such as the well-known Generalized Likelihood Ration test, may be used in an embodiment of the present invention for the main scheme, and additional or different supplemental schemes may be provided as well. Quantities derived by applying the disclosed analysis enable assessing the deviation from on-target conditions and estimating change-points, and may be used in various types of tests (as exemplified by the discussion, above, of the last good period). The disclosed approach is not dependent on sample size, and accommodates time-latent data.

Note that the disclosed techniques may be used generalized to detecting various types of changes without deviating from the scope of the present invention. For example, the main scheme may be tuned using the parameter gamma to achieve a trade-off between detection performance for drifts (which are gradual changes in a process) and shifts (which are sudden changes in the process). Or, the main scheme may be used to detect intermittent trends (including under the conditions of time-lagged data) while the supplemental schemes are focused on detection of ongoing trends.

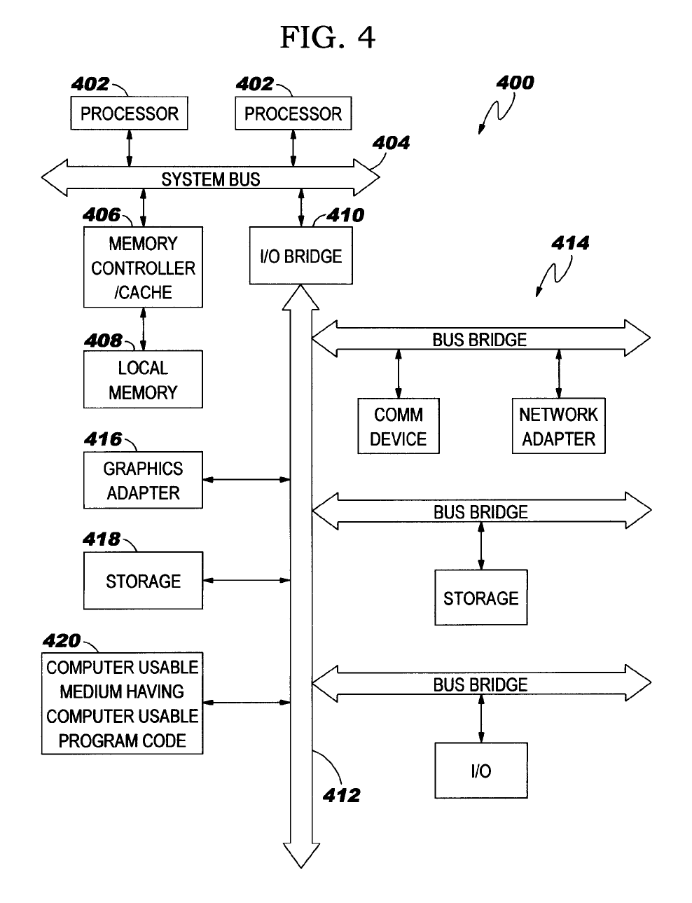

Referring now to FIG. 4, a block diagram of a data processing system is depicted in accordance with the present invention. Data processing system 400, such as one of the processing devices described herein, may comprise a symmetric multiprocessor (“SMP”) system or other configuration including a plurality of processors 402 connected to system bus 404.

Alternatively, a single processor 402 may be employed. Also connected to system bus 404 is memory controller/cache 406, which provides an interface to local memory 408. An I/O bridge 410 is connected to the system bus 404 and provides an interface to an I/O bus 412. The I/O bus may be utilized to support one or more buses 414 and corresponding devices, such as bus bridges, input output devices (“I/O” devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 416, storage 418, and a computer usable storage medium 420 having computer usable program code embodied thereon. The computer usable program code may be executed to execute any aspect of the present invention, as have been described herein.

The data processing system depicted in FIG. 4 may be, for example, an IBM System p® system, a product of International Business Machines Corporation in Armonk, N.Y., running the Advanced Interactive Executive (AIX®) operating system. An object-oriented programming system such as Java may run in conjunction with the operating system and provides calls to the operating system from Java® programs or applications executing on data processing system. (“System p” and “AIX” are registered trademarks of International Business Machines Corporation in the United States, other countries, or both. “Java” is a registered trademark of Sun Microsystems, Inc., in the United States, other countries, or both.)

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), DVD, an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages such as the “C” programming language or similar programming languages. The program code may execute as a stand-alone software package, and may execute partly on a user's computing device and partly on a remote computer. The remote computer may be connected to the user's computing device through any type of network, including a local area network (“LAN”), a wide area network (“WAN”), or through the Internet using an Internet Service Provider.

Aspects of the present invention are described above with reference to flow diagrams and/or block diagrams of methods, apparatus (systems), and computer program products according to embodiments of the invention. It will be understood that each flow or block of the flow diagrams and/or block diagrams, and combinations of flows or blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram flow or flows and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram flow or flows and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flow diagram flow or flows and/or block diagram block or blocks.

Flow diagrams and/or block diagrams presented in the figures herein illustrate the architecture, functionality, and operation of possible implementations of systems, methods, and computer program products according to various embodiments of the present invention. In this regard, each flow or block in the flow diagrams or block diagrams may represent a module, segment, or portion of code, which comprises one or more executable instructions for implementing the specified logical function(s). It should also be noted that, in some alternative implementations, the functions noted in the flows and/or blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flow of the flow diagrams, and combinations of blocks in the block diagrams and/or flows in the flow diagrams, may be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1-10. (canceled)

11. A system for detecting emerging trends in process control data, comprising:
a computer comprising a processor; and
instructions which are executable, using the processor, to implement functions comprising:
applying a Repeated Weighted Geometric Cumulative Sum analysis to process control data to determine whether a threshold is exceeded for the process control data; and
flagging the process control data if the threshold is exceeded.

12. The system according to claim 11, wherein the Repeated Weighted Geometric Cumulative Sum analysis comprises iterating over N intervals, each iteration computing a weighted cumulative sum that summarizes all previous evidence against an assumption that an underlying process represented by the process control data is acceptable.

13. The system according to claim 12, wherein each iteration of the Repeated Weighted Geometric Cumulative Sum analysis further comprises:
computing a weighted deviation of a current one of the N intervals from an approximation of a midway point between evidence that an underlying process represented by the process control data is acceptable and evidence that the underlying process is unacceptable; and
adding the computed weighted deviation to a value computed at a previous one of the N intervals as the weighted cumulative sum that summarizes all previous evidence against an assumption that the underlying process is acceptable, thereby generating a new value for the weighted cumulative sum, where an initial one of the N intervals uses a value of zero as the value computed at the previous one of the N intervals.

14. The system according to claim 11, wherein the functions further comprises:
computing a last good period from the process control data by applying the Repeated Weighted Geometric Cumulative Sum analysis to locate a point M in the process control data that represents a peak in the process control data, the point M starting a segment in the process control data in which a value computed by multiplying the threshold by a ratio is not exceeded up through a current time T, the segment following an earlier point in the process control data where the value is exceeded.

15. The system according to claim 11, further comprising applying at least one supplemental test in addition to the Repeated Weighted Geometric Cumulative Sum analysis to determine whether to flag the process control data, the at least one supplemental tests comprising at least one of:
a comparison of a number of failures in a most-recent period of the process control data to a failure-count threshold computed so as to assure a first pre-specified false alarm probability;
a determination of whether extreme intermediate points are observed in any of N intervals in the process control data; and
a comparison of a last point of an evidence curve to a threshold computed so as to assure a second pre-specified false alarm probability.

16. A computer program product for detecting emerging trends in process control data, the computer program product comprising:
a computer readable storage medium having computer readable program code embodied therein, the computer readable program code configured for:
applying a Repeated Weighted Geometric Cumulative Sum analysis to process control data to determine whether a threshold is exceeded for the process control data; and
flagging the process control data if the threshold is exceeded.

17. The computer program product according to claim 16, wherein the Repeated Weighted Geometric Cumulative Sum analysis further comprises iterating over N intervals, each iteration beyond an initial iteration using evidence from a previous one of the N intervals in combination with a weighted deviation of a current one of the intervals from an approximation of a midway point between evidence that an underlying process represented by the process control data is acceptable and evidence that the underlying process is unacceptable, such that a value is computed at each interval as a weighted cumulative sum that summarizes all previous evidence against an assumption that the underlying process is acceptable.

18. The computer program product according to claim 16, wherein the computer readable program code configured for is further configured for:
computing a last good period from the process control data by applying the Repeated Weighted Geometric Cumulative Sum analysis to locate a point M in the process control data that represents a peak in the process control data, the point M starting a segment in the process control data in which a value computed by multiplying the threshold by a ratio is not exceeded up through a current time T, the segment following an earlier point in the process control data where the value is exceeded.

19. The computer program product according to claim 16, wherein the computer readable program code configured for is further configured for:
generating a threshold for use in the Repeated Weighted Geometric Cumulative Sum analysis using parallel simulation runs with power-exponential tail approximations.

20. The computer program product according to claim 16, wherein the Repeated Weighted Geometric Cumulative Sum analysis detects trends in fall-out rate of an underlying process represented by the process control data based on non-time-to-failure data that corresponds to counts of failures in consecutive time periods for which the process control data is obtained.

21-23. (canceled)
